(19) United States
(12) Patent Application Publication
(10) Pub. No.: US 2018/0349381 A1
(43) Pub. Date: Dec. 6, 2018

(54) MULTIMEDIA OBJECT RECOMMENDATION METHOD, DEVICE, SYSTEM, TERMINAL, AND SERVER

(71) Applicant: Alibaba Group Holding Limited, George Town (KY)

(72) Inventors: Shanwen Shi, Hangzhou (CN); Hujing Luo-Peng, Hangzhou (CN); Haoyu Fan, Hangzhou (CN); Sun Li, Hangzhou (CN)

(21) Appl. No.: 15/771,953

(22) PCT Filed: Oct. 25, 2016
(86) PCT No.: PCT/CN2016/103138

§ 371 Date: Apr. 27, 2018

(30) Foreign Application Priority Data
Nov. 3, 2015 (CN) 201510740336.6

(51) Int. Cl. G06F 17/30; H04W 4/02

(52) U.S. Cl. CPC G06F 17/30053; H04W 4/025; G06F 17/30061; G06F 17/30041

(57) ABSTRACT

The embodiments of the present application provide a method, devices, a system, terminals and a server for recommending multimedia objects, and the method comprises: acquiring the location associated with a first terminal; acquiring the multimedia object information related to the location, wherein the multimedia objects comprise ones played at the location and recommended by at least one user; and recommending the multimedia object to the first terminal. The multimedia object recommendation scheme in the embodiments of the present application enables a terminal to receive not exactly the same multimedia objects at different locations, thus improving the user experience.

### CROSS REFERENCE TO OTHER APPLICATIONS

This application claims priority to International (PCT) Application No. PCT/CN16/103138 entitled MULTIMEDIA OBJECT RECOMMENDATION METHOD, DEVICE, SYSTEM, TERMINAL, AND SERVER, filed Oct. 25, 2016 which is incorporated herein by reference for all purposes, which claims priority to People's Republic of China Patent Application No. 201510740336.6 entitled METHOD, DEVICE, SYSTEM, TERMINAL AND SERVER FOR RECOMMENDING MULTIMEDIA OBJECTS, filed Nov. 3, 2015 which is incorporated herein by reference for all purposes.

### FIELD OF THE INVENTION

The present application relates to communications technology; in particular, it relates to a method, devices, a system, terminals, and a server for multimedia object recommendation.

### BACKGROUND OF THE INVENTION

A typical process of the prior art methods for recommending multimedia objects such as music is as follows: acquiring by a server the data of a user's stream operation on multimedia objects, analyzing these data with algorithms to estimate the user's favorite multimedia objects, and recommending similar multimedia objects to the user by the server.

Using prior art methods for recommending multimedia objects, the multimedia objects recommended to the user are lacking variety.

### SUMMARY OF THE INVENTION

The embodiments of the present application provide a method, devices, a system, terminals, and a server for recommending multimedia objects, to solve the problem in the prior art, that is, the lack of variety of recommended multimedia objects.

According to the first aspect of the embodiments of the present application, a method for recommending multimedia comprises: acquiring a location associated with a first terminal; acquiring information of the multimedia objects related to the location, wherein the multimedia objects comprise ones played at the location and recommended by at least one user; and recommending said multimedia objects to the first terminal.

According to the second aspect of the embodiments of the present application, a method for recommending multimedia objects comprises: receiving a location associated with a first terminal; querying information of multimedia objects related to the location, wherein said multimedia objects comprise ones played at the location and recommended by at least one user; and recommending said multimedia objects to the first terminal.

According to the third aspect of the embodiments of the present application, a method for recommending multimedia objects comprises: acquiring information of a multimedia object that is currently playing at the second terminal and the location recommended to play the multimedia object; and sending to the server the multimedia object information and the location recommended to play the multimedia object.

According to the fourth aspect of the embodiments of the present application, a device for recommending multimedia objects comprises: a first acquisition module for acquiring the location associated with a first terminal; a second acquisition module for acquiring the multimedia object information related to the location, wherein said multimedia objects comprise ones played at the location and recommended by at least one user; and a recommendation module for recommending the multimedia objects to the first terminal.

According to the fifth aspect of the embodiments of the present application, a device for recommending multimedia objects comprises: a location receiving module for receiving the location associated with a first terminal; a query module for querying the multimedia object information related to the location, wherein said multimedia objects comprise ones played at the location and recommended by at least one user; and a sending module for sending the multimedia object information to the first terminal.

According to the sixth aspect of the embodiments of the present application, a device for recommending multimedia objects comprises: a recommendation message acquisition module for acquiring information of a multimedia object that is currently playing at the second terminal and the location recommended to play the multimedia object; and a recommendation message sending module for sending to the server the multimedia object information and the location recommended to play the multimedia object.

According to the seventh aspect of the embodiments of the present application, a terminal comprises: a device for recommending multimedia objects as described in the fourth aspect above.

According to the eighth aspect of the embodiments of the present application, a server comprises: a device for recommending multimedia objects as described in the fifth aspect above.

According to the ninth aspect of the embodiments of the present application, a terminal comprises: a device for recommending multimedia objects as described in the sixth aspect above.

According to the tenth aspect of the embodiments of the present application, a system for recommending multimedia objects comprises: a first terminal comprising a device for recommending multimedia objects as described in the fourth aspect above; a second terminal comprising a device for recommending multimedia objects as described in the sixth aspect above; and a server comprising a device for recommending multimedia objects as described in the fifth aspect above.

With the multimedia object recommendation scheme in the embodiments of the present application, it is possible, based on the location associated with a first terminal, to recommend multimedia objects recommended by users to play at the location to the first terminal. Since multimedia objects are typically recommended to the first terminal, and those recommended at different locations are not exactly the same, the multimedia objects playing in the first terminal are diversified, thus improving the user experience.

### BRIEF DESCRIPTION OF THE DRAWINGS

Various embodiments of the invention are disclosed in the following detailed description and the accompanying drawings.

The drawings described here are intended to further the understanding of the present application and form a part of the present application. The illustrative embodiments of the present application and the descriptions thereof are intended to explain the present application and do not constitute inappropriate limitation of the present application. Among the drawings:

FIG. 1 is a flowchart of a multimedia object recommendation method in embodiment 1 of the present application.

FIG. 2 is a flowchart of a multimedia object recommendation method in embodiment 2 of the present application.

FIG. 3 is a flowchart of a multimedia object recommendation method in embodiment 3 of the present application.

FIG. 4 is a schematic structural diagram of a multimedia object recommendation device in embodiment 4 of the present application.

FIG. 5 is a schematic structural diagram of a multimedia object recommendation device in embodiment 5 of the present application.

FIG. 6 is a schematic structural diagram of a multimedia object recommendation device in embodiment 6 of the present application.

FIG. 7 is a schematic structural diagram of a terminal comprising a multimedia object recommendation device in embodiment 7 of the present application.

FIG. 8 is a schematic structural diagram of a server comprising a multimedia object recommendation device in embodiment 8 of the present application.

FIG. 9 is a schematic structural diagram of a terminal comprising a multimedia object recommendation device in embodiment 9 of the present application.

FIG. 10 is a schematic structural diagram of a multimedia object recommendation system in embodiment 10 of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

To make the technical schemes and advantages of the present invention more clear, the present invention is described in further detail below in light of the drawings and exemplary embodiments herein. Obviously, the embodiments described are only some, but not all, of the embodiments of the present application. It needs to be explained that the embodiments and the features in the embodiments of the present application can be combined with each other where there are no conflicts.

In the process of realizing the present application, the applicant discovered that in the prior art methods for recommending multimedia objects, a server filters multimedia objects acquired through data collection with ad-hoc algorithms before recommending the filtered multimedia object information to the user, and then the user queries or searches the recommended multimedia objects in the server. Generally, multimedia objects recommended based on algorithms are lacking variety.

There are other methods for recommending multimedia objects in the related art, for example, user A recommends to his/her friend user B one or one type of multimedia object. These multimedia object recommendation methods also have the typical problem of lacking variety.

To address the problem described above, the embodiments of the present application provide a method, devices, a system, terminals, and a server for recommending multimedia objects, which makes it possible to, based on the location associated with a first terminal, recommend to the first terminal the multimedia objects recommended by users to play at the location. Since multimedia objects are typically recommended to the first terminal, and those recommended at different locations are not exactly the same, the multimedia objects playing in the first terminal are diversified, thus improving the user experience.

The schemes of the embodiments of the present application can be applied in products related to location or multimedia objects, such as Internet of Vehicles systems, mobile terminal systems, and other systems such as map systems and multimedia object player systems.

The multimedia object recommendation schemes in the embodiments of the present application can be implemented by using computer languages, such as C++, object-oriented programming language Java language, JS (JavaScript, literal translation script) language in Aliyun OS (Operating System, OS), Android, Apple iOS, Microsoft's WinCE (Windows Embedded Compact, embedded operating system), and other operating systems.

### Embodiment 1

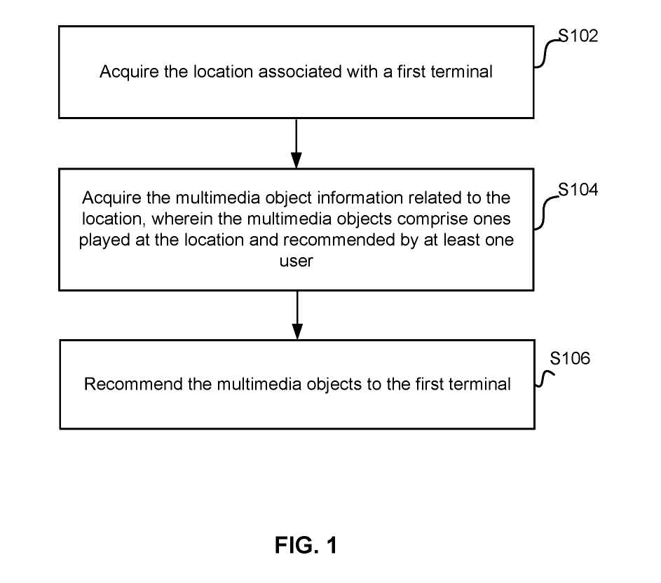

FIG. 1 is a flowchart of a multimedia object recommendation method in embodiment 1 of the present application.

As shown in FIG. 1, the method for recommending multimedia objects in embodiment 1 of the present application comprises the following steps:

S102, acquiring a location related to a first terminal;

S104, acquiring the multimedia object information associated with the location, which comprises the multimedia objects played at the location and recommended by at least one user;

S106, recommending the multimedia objects to the first terminal.

In the embodiments of the present application, a first terminal may be any type of terminal that is installed with location-related or multimedia object-related products, such as a vehicle-mounted terminal, a mobile terminal, or a portable computer; location-related products may comprise map applications; and multimedia object-related products may comprise multimedia players and radios.

In the embodiments of the present application, users recommending multimedia objects to be played at a location may comprise a user of a first terminal or other users, and may be one user or multiple users; the present application imposes no restrictions in this regard.

In the specific embodiment 1 of step S102, the location associated with the first terminal can be the current location of the first terminal; for example, latitude and longitude information of the current location of the first terminal, or the location information of the residential complex or building in which the first terminal is located; it can also be a location of the first terminal in a logical space, for example, home, office, or cafe.

The method for recommending multimedia objects in the embodiments of the present application enables a first terminal to acquire the multimedia objects recommended by users to play at the first terminal's current location.

In the specific embodiment 2 of step S102, the location associated with the first terminal may also be a first location area with a defined range, which includes the current location of the first terminal; for example, a road along which the first terminal is traveling, such as “West Wenyi Road,” or the area in which the first terminal is located, such as “Beihai Park.”

The method for recommending multimedia objects in the embodiments of the present application enables a first terminal to acquire the multimedia objects recommended by users to play at the first terminal's current location area.

In the specific embodiment 3 of step S102, the location associated with the first terminal may also be a second defined location which is the target location of the first terminal; for example, the location at which the first terminal is arriving; or a location where the first terminal intends to acquire multimedia object information; persons skilled in the art can understand, for example, that the second location may be the latitude and longitude information of the target location of the first terminal, or the location information of the residential complex or building in which the target location of the first terminal is located; it can also be a target location of the first terminal in a logical space, for example, home, office, or cafe.

The method for recommending multimedia objects in the embodiments of the present application enables a first terminal to acquire the multimedia objects recommended by users to play at the target location of the first terminal.

In the specific embodiment 4 of step S102, the location associated with the first terminal may also be a second location area with a defined range, which is the target area of the first terminal; for example, a location area at which the first terminal is arriving; for example, a road along which the first terminal is about to travel, such as “West Wenyi Road,” or the area that the first terminal is approaching, such as “Beihai Park.”

In the embodiments 3 and 4 of the above step S102, a defined entrance may be provided to the user to set up the second location or the second location area. After the user enters the defined entrance, he/she can input the information of the second location or the second location area, or after the user enters the defined entrance, he/she can select, from the location information displayed, the second location or the second location area. The location information can be displayed to the user in various ways, for example, displaying a location table or using a map interface to display the corresponding location name at each location or the second location area. If the user wants to select a location, he/she can click the location or the location area as the user-selected second location or location area.

The method for recommending multimedia objects in the embodiments of the present application enables a first terminal to acquire the multimedia objects recommended by users to play at the target location area of the first terminal.

In embodiments 1 through 4 of step S102 as described above, a location associated with the first terminal may comprise various forms, for example, the current location of the first terminal (such as the first location or the first location area), or the target location of the first terminal (such as the second location or the second location area) which comprises the location at which the first terminal plans to arrive. If in step S102, the location associated with the first terminal is the current location of the first terminal, then in step S106, the multimedia objects can be recommended to the first terminal from the first terminal's current location; if in step S102, the location associated with the first terminal is the target location of the first terminal, then in step S106, after detecting the arrival of the first terminal at the target location, the multimedia objects are recommended to the first terminal at the target location.

In a specific embodiment of step S102, the location associated with the first terminal can be obtained by acquiring the location verified by the user in a map application in the first terminal; or by acquiring the location verified by the first terminal through its positioning feature.

For example, positioning can be accomplished by the first terminal's Global Positioning System (GPS); if the first terminal is a mobile terminal, the residential complex in which the mobile terminal is located can be used for positioning; various map applications in the first terminal can also be used for positioning, for example, a user labels related locations in applications such as Gaode Map, Careland Map, Baidu Map; if the user-related location is in a logical space, the related location can be acquired as home or office, etc. according to the user's settings, and the logical space location can also be determined by the geological location labeled by the user, for example, if the geological location acquired is an office building, then the location associated with the first terminal determined is office, and the present application imposes no restrictions in this regard.

In a specific embodiment of step S102, the location associated with the first terminal may be acquired according to a defined cycle; that is, acquiring the location associated with the first terminal once every cycle. During specific implementation, the defined cycle may be, for example, 1 min, 3 min, or 10 min. The defined cycle can be a system default or defined by the user in the first terminal.

In a specific embodiment of step S102, the location associated with a first terminal may also be acquired if, after an acquisition, it is detected that the position change of the first terminal exceeds the first defined range, that is, acquiring the location associated with the first terminal based on the distance the first terminal changes its position. For example, after acquiring the location of the first terminal, if it is found that the distance between the first terminal and the last acquired position is more than 30 meters, then the current position of the first terminal is acquired. The first defined cycle can be system default or defined by the user in the first terminal.

The method for recommending multimedia objects in the embodiments of the present application enables a first terminal to continuously acquire the multimedia objects recommended by users with changes in time or location of the first terminal, in order to recommend different multimedia objects to a user with changes in the user's location.

In an embodiment of step S104, the location-related multimedia object information can be acquired by sending the location to a server and receiving the multimedia object information sent by the server based on the location. Specifically, information of multimedia objects recommended by each user is stored in the server, and their corresponding play location information is also stored with relationships. Specific implementation of the server will be described in detail in the embodiment 2 below.

In a specific embodiment of step S104, the location-related multimedia object information can be acquired by querying the multimedia object information related to the location from the locally stored history information.

In a specific embodiment of step S104, both local query and server query can be used, for example, location-related multimedia object information can be acquired from the server if the network works well, or acquired locally if the network doesn't work well or is unavailable. Or, after acquiring the location information, the multimedia object information related to the location can be queried from the history information stored locally. If the query finds no result or only a few results, the location can be sent back to the server and the multimedia object information can be sent by the server based on the location.

In a specific embodiment of the present application, the multimedia object information related to said location can be actively acquired by the first terminal; that is, after acquiring the location information, it actively acquires the multimedia object information related to the location.

In a specific embodiment of the present application, the acquisition of the multimedia object information related to the location can also be triggered by the user's operation; that is, receiving a first operation command made by the user before acquiring the multimedia object information related to the location.

During specific implementation, the first operation command can be a command for operating a first defined button which is used to trigger the acquisition of multimedia object information; the first defined button can be a virtual button in the application interface or a physical button on the first terminal; or a confirmation to the application's pop-up prompt box “Acquire user-recommended multimedia objects?” For example, the user can click the “Collect” button in the application interface to trigger the acquisition of multimedia object information.

During specific implementation, the first operation command can also be a command for operating a defined application which comprises a map application or a multimedia player application. The operation command to the defined application can be opening the defined application, switching it from background to foreground, switching it to a corresponding mode, or dragging to browse by the user, etc., for example, the user opens the “Music Map,” or switches a map application to the “Music Map” mode.

Still taking Beijing as an example, user A opens the map application while driving by Houhai, and the map application displays the multimedia objects recommended for Houhai.

In a specific embodiment of the present application, if the number of pieces of multimedia object information acquired is greater than a first defined value, then the number of pieces of the multimedia object information acquired will be reduced according to the first defined value; that is, when information is acquired on many multimedia objects, the number will be reduced according to the defined value. During specific implementation, the first defined value can be system default or defined by the user in the first terminal; the first defined value can be a number such as 10 or 100.

During specific implementation, a variety of ways can be used to reduce the number of pieces of multimedia object information acquired. For example, when the number of pieces of multimedia object information acquired is more than 10, only the first 10 pieces of information are acquired; or by sorting the information based on how many times it has been recommended and/or how many people have recommended it, and the top 10 songs with the highest recommendation counts or people counts are picked and recommended to the user.

In a specific embodiment of the present application, after acquisition, the multimedia object information acquired can be added to the playlist of the multimedia player application in the first terminal.

During specific implementation, the number of pieces of multimedia object information in the playlist of the multimedia player application can be controlled. That is, if the number of pieces of multimedia object information in the multimedia player application's playlist is greater than a second defined value, it will be controlled to be equal to or less than the second defined value. During specific implementation, the second defined value can be system default or defined by the user in the first terminal; the second defined value can be a number such as 10 or 100.

During specific implementation, the second defined value may be the same as or different from the first defined value described above; preferably, the second defined value is greater than or equal to the first defined value.

During specific implementation, a variety of ways can be used to control the number of multimedia objects in the playlist. For example, deleting the newly acquired multimedia object information; deleting multimedia object information older than the newly added ones; or deleting randomly.

In the embodiments of the present application, the corresponding user of the first terminal can also register on the server in order to allow the server to store the corresponding information for the user according to the registered user name, for example, playlists, multimedia objects recommended by the user, and locations where the multimedia objects played.

In a specific embodiment of the present application, after adding the multimedia object information acquired to the playlist in the multimedia player application in the first terminal, it further comprises reporting the playlist to the server.

Sending the playlist to the server enables the user to obtain playlists corresponding to the user name even if the terminal is replaced, thereby improving the user experience.

In a specific embodiment of step S104, the multimedia object information can be the content of the multimedia object. That is, multimedia objects can be directly received from the server and cached in the first terminal.

In a specific embodiment of step S104, the multimedia object information can also be the multimedia object identifier ID. During specific implementation, the identifier ID can be the name, number or other information used to identify the multimedia object.

During specific implementation, if the multimedia object information comprises the identifier ID, then after acquiring the location-related multimedia object information, it also comprises: acquiring the multimedia object content according to the ID. During specific implementation, the corresponding multimedia object can be found by searching on the Internet with this ID, or by searching locally or on the server with this ID.

During specific implementation, while receiving the multimedia object information sent by the server, the corresponding latitude and longitude information of these multimedia objects and the information of a second user who recommended the multimedia objects can also be received from the server.

Taking Beijing as an example, when user A is driving by Houhai, his/her terminal detects his/her current position is “39°56′25.89″N 116°22′ 35.22″E,” and then sends “39°56′25.89″N 116°22′35.22″E” as user A's position to the server. After receiving the information, the server queries multimedia objects corresponding to the position, and then sends these multimedia objects and their corresponding latitude and longitude information to user A.

In a specific embodiment of step S104, the multimedia object may comprise music and the multimedia player applications comprise music players.

In a specific embodiment of step S104, the multimedia or multimedia objects may also comprise channels and the multimedia player applications comprise radios.

In a specific embodiment of step S106, the multimedia recommendation identifier can be displayed in a map interface containing the location in order to recommend the multimedia object to the first terminal. During specific implementation, the multimedia recommendation identifier can be displayed anywhere on a map interface in different ways, for example, the multimedia recommendation identifier can be highlighted or flashing.

In a specific embodiment of step S106, the multimedia recommendation identifier can be displayed at the location in the map interface in order to recommend the multimedia object to the first terminal. During specific implementation, the multimedia recommendation identifier can be displayed anywhere in a map interface in different ways, for example, the multimedia recommendation identifier can be displayed by being highlighted or flashing at the location.

In a specific embodiment of step S106, if the location comprises at least two sub-locations, that is, the location associated with the first terminal is a location area (current location area or target location area) which comprises multiple sub-locations each with different multimedia objects recommended by users, then the multimedia recommendation identifier can be displayed at each sub-location; wherein, the multimedia objects corresponding to each sub-location are not exactly the same.

In a specific embodiment of step S106, the multimedia recommendation identifier can be a universal identifier for multimedia objects, such as a musical note icon, a music record icon or a radio icon; it can also be an identifier of one object of the multimedia objects; for example, a headshot of the author of a multimedia object.

During specific implementation, a multimedia recommendation identifier can be displayed in various ways as follows: for example, when a user opens the application, it displays at the default scale, locations in the vicinity of the user and their corresponding recommended multimedia objects; or when the user zooms the map, it displays in a larger range, locations and their corresponding multimedia objects; under the same scale, multimedia objects with higher weights and their corresponding locations can be preferentially displayed, with the weights defined based on predetermined information such as the number of people who made recommendations and/or the number of recommended multimedia objects; and when the user drags the map, the application can also update and display recommended multimedia objects and their corresponding locations in the corresponding area.

In a specific embodiment of step S106, after displaying the multimedia object recommendation identifier in the map interface, it further comprises: playing the multimedia object according to the multimedia object information. That is, after displaying the multimedia object identifier in the map interface, the multimedia object can be automatically played according to the multimedia object information.

In a specific embodiment of step S106, the multimedia object can be played based on how the user operates the multimedia recommendation identifier. That is, before playing the multimedia object according to the multimedia object information, it further comprises: receiving the user's operation on the multimedia object recommendation identifier.

In a specific embodiment of step S106, after acquiring the multimedia object information, and based on which, the multimedia object will be directly played in order to recommend the multimedia object to the first terminal.

In a specific embodiment of the present application, it further comprises: reporting to the server the first terminal's current play information which comprises the first terminal's current location information and the multimedia object playing in the terminal.

During specific implementation, the first terminal's current play information can be periodically reported to the server, that is, according to a defined cycle, the first terminal's current play information can be reported to the server; the defined cycle can be a duration such as 5 min or 10 min; or, the information can be reported to the server once every certain distance, that is, if the position change of the first terminal exceeds a second defined range, the first terminal's play information will be reported to the server; the second defined range can be a distance such as 30 m or 50 m.

During specific implementation, multimedia objects can be played with a variety of multimedia object applications, such as Xiami Music, Baidu Music and QQ music.

During specific implementation, besides multimedia object recommendations, other information about the second user who recommended the multimedia object can also be provided to the first server, for example, the number of users who recommended this multimedia object, the second user's user name, and recommendation reasons. The present application imposes no restrictions in this regard.

The following example explains an implementation of the method for recommending multimedia objects in the embodiments of the present application.

When user A is driving by Houhai, the client detects that the user A's current location is “Houhai” and acquires a piece of “Houhai”-related music, “Beijing Beijing,” recommended by a user at this location. Thus, it is displayed on the user A's map that the related music recommendation has been acquired, and “Beijing Beijing” is playing.

With the method for recommending multimedia objects in the embodiments of the present application, multimedia objects recommended to play at this location are recommended to the user of the first terminal, based on the location associated with the first terminal. Since multimedia objects are typically recommended to the first terminal, and those recommended at different locations are not exactly the same, the multimedia objects playing in the first terminal are diversified, thus improving the user experience.

### Embodiment 2

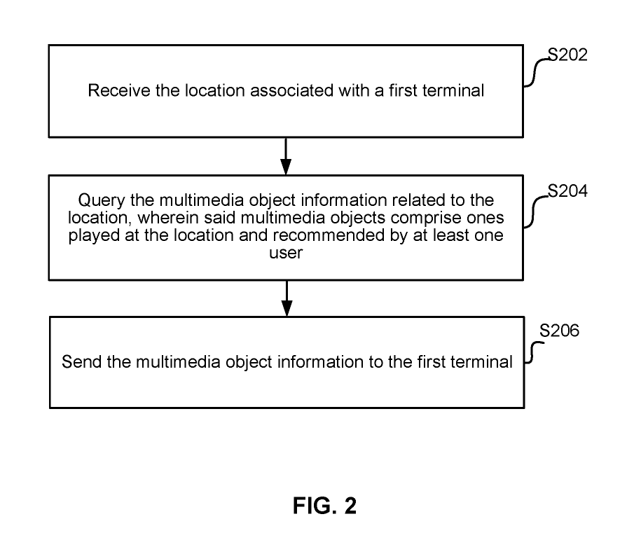

FIG. 2 is a flowchart of a multimedia object recommendation method in embodiment 2 of the present application.

As shown in FIG. 2, the multimedia object recommendation method in embodiment 2 of the present application comprises the following steps:

S202, receiving a location associated with the first terminal;

S204, querying the information of multimedia objects related to this location, which comprises multimedia objects played at the location and recommended by at least one user;

S206, sending the multimedia object information to the first terminal.

During specific implementation, the multimedia object recommendation method can be applied in a map cloud server for multimedia objects.

In the specific embodiment of the present application, the server can maintain a database of the correspondence relationship between multimedia objects and locations; that is, in the database, the multimedia object recommended by users and the location recommended to play the multimedia object are stored; in a specific implementation, the correspondence relationship between multimedia objects and locations can be stored in various ways, for example, by creating a table to store one or more multimedia objects corresponding to a certain location.

In the embodiments of the present application, the server can receive the user's registration and login. The server stores, for the user, the user information according to the user name, for example, uploaded playlists, multimedia objects recommended by the user, and locations playing the multimedia objects.

During specific implementation, the server not only stores the correspondence relationship between multimedia objects and locations, it can further store the number of users who recommend a multimedia object, their user names, and reasons for recommendation.

During specific implementation, the recommendation reason can be system-generated labels with common recommendation reasons for the user to choose; reasons manually input by the user can also be received.

During specific implementation, the correspondence relationship between multimedia objects and locations can be shown in the table below:

| | Music | Number of users | User who |
|---|---|---|---|
| Location | recommended | who recommend | recommends |
| West Wenyi Road, | a | 3 | xq, ax, aaa |
| Section A | b | 2 | Yy, bb |
| West Wenyi Road, | c | 5 | Aaa, xq, bb, |
| Section B | | | yy, ix |

In a specific embodiment of the present application, the multimedia object information related to the location can be a recommendation message triggered by the user's action. The recommendation message comprises the multimedia object information and the location recommended to play the multimedia object. That is, before the server queries the multimedia object information related to the location, it also comprises: receiving recommendation messages from at least one user; and storing the correspondence relationship between the multimedia object and the location.

In a specific embodiment of the present application, the multimedia object information related to the location can be the play information automatically sent by a second terminal. The play information comprises the current location of the second terminal and the information of the multimedia objects playing in the second terminal; that is, before the server's querying and storing the multimedia object information related to the location, it also comprises: receiving and storing the second terminal's play information; and based on which, verifying and storing the correspondence relationship between the multimedia object and the location.

In a specific embodiment of the present application, it can also send and store the first terminal's playlists to enable the user to obtain the playlists corresponding to the user name even if the terminal is replaced, thereby improving the user experience.

With the method for recommending multimedia objects in the embodiments of the present application, it is possible to receive the location associated with the first terminal, and query the multimedia objects related to the location which plays at the location with recommendations from at least one user. Since multimedia objects typically recommended to the first terminal at different locations are not exactly the same, there is a variety of multimedia objects playing at the first terminal, thus improving the user experience.

### Embodiment 3

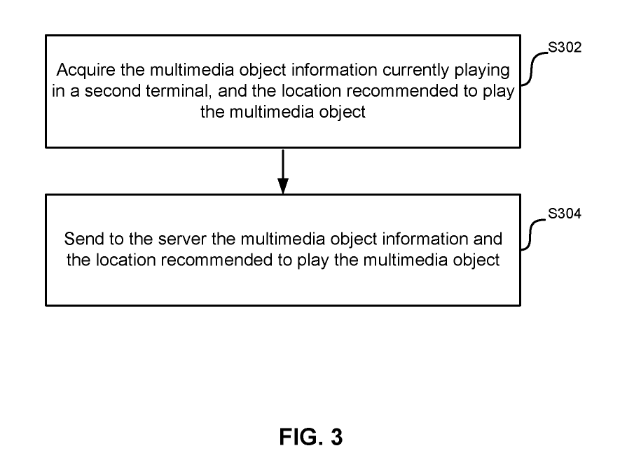

FIG. 3 is a flowchart of a multimedia object recommendation method in embodiment 3 of the present application.

As shown in FIG. 3, the method for recommending multimedia objects in embodiment 3 of the present application comprises the following steps:

S302, acquiring the information of the multimedia object currently playing in the second terminal, and the location recommended to play the multimedia object;

S304, sending the information of the multimedia object and the location recommended to play the multimedia object.

In the embodiments of the present application, a second terminal may be any type of terminal installed with location-related or multimedia object-related products, such as a vehicle-mounted terminal, a mobile terminal, a portable computer; location-related or multimedia object-related products may comprise map applications and multimedia players, etc.

In the embodiments of the present application, the corresponding user of the second terminal can register on the server in order to allow the server to store the corresponding information for the user according to the registered user name, for example, playlists, multimedia objects recommended by the user, and locations recommended to play the multimedia objects.

In the first specific embodiment of Step S302, information of the multimedia object currently playing can be acquired from the multimedia player application in the second terminal. During specific implementation, the multimedia player application can be a multimedia player or radio. During specific implementation, the multimedia object information can be the content of the multimedia object; it can also be the identifier ID of the multimedia object, such as the name, number, or channel. The multimedia object currently playing can also be recognized by a speech recognition device.

In the second specific embodiment of Step S302, the location recommended to play the multimedia object can be the current location of the second terminal. Examples include the latitude and longitude information of the current location of the second terminal, or location information of the residential complex or building in which the second terminal is located; it can also be the location of the second terminal in a logical space, for example, home, office, or cafe.

With the method for recommending multimedia objects in the embodiment of the present application, the user is able to recommend the multimedia object playing at the current location.

In the third specific embodiment of step S302, the location recommended to play the multimedia object can be a third location area with a defined range, and the third location area comprises the current location of the second terminal. Examples include a road along which the second terminal is traveling, such as “West Wenyi Road,” or the area in which the first terminal is located, such as “Beihai Park.”

With the method for recommending multimedia objects in the embodiment of the present application, the user is able to recommend the multimedia object playing at the current location area.

In a specific embodiment of step S302, the location recommended to play the multimedia object can be a fourth location area with a defined range, and the fourth location area can be any location area designated by the user; for example, any location that the user thinks suitable to play the multimedia object, such as “West Wenyi Road” or “home.”

With the method for recommending multimedia objects in the embodiments of the present application, the user is able to recommend multimedia objects playing at any location area.

In a specific embodiment of step S302, the location associated with the second terminal can be obtained by acquiring the location verified by the user through a map application in the second terminal; or by acquiring the location verified by the second terminal through its positioning feature.

For example, GPS in the second terminal can be used for positioning; if the second terminal is a mobile terminal, the residential complex where the mobile terminal is located can also be used for positioning; any map application in the second terminal can also be used for positioning, for example, a user labels the related locations in applications such as Gaode Map, Careland Map, Baidu Map; if the location recommended by the user to play the multimedia object is in a logical space, the location can be acquired as home or office, etc., according to the user's settings, and the logical space location can also be determined by the geological location labeled by the user, for example, if the geological location acquired is an office building, then the location recommended by the user to play the multimedia object is determined to be office. The present application imposes no restrictions in this regard.

In a specific embodiment of the present application, the recommendation process can be automatically triggered after the user logged in to the application, to acquire the information of the multimedia object currently playing in the second terminal and the location recommended to play the multimedia object;

In a specific embodiment of the present application, recommendation can be triggered by the user, that is, after the user logged in to the application, receiving a second operation command input by the user in the second terminal, followed by acquiring the information of the multimedia object currently playing in the second terminal and the location recommended to play the multimedia object.

During specific implementation, the second operation command comprises: a command for operating a second defined button in the interface of the map application or multimedia player application. The second defined button is used to trigger the operation to acquire the information of the multimedia object currently playing and the location recommended to play the multimedia object. During specific implementation, the second defined button can be the “Recommend” button in the multimedia player application, or the “Recommend the multimedia object” button in the map application, etc. The present application imposes no restrictions in this regard.

In a specific embodiment of the present application, it further comprises: reporting to the server the second terminal's current play information which comprises the second terminal's current location information and information of the multimedia object playing in the terminal.

During specific implementation, the first terminal's current play information can be periodically reported to the server, that is, according to a defined cycle, the second terminal's current play information can be reported to the server; the defined cycle can be a duration such as 5 min or 10 min; or the information can be reported to the server once every certain distance, that is, if the position change of the second terminal exceeds a third defined range, the second terminal's play information will be reported to the server; the third defined range can be a distance such as 30 m or 50 m.

In a specific embodiment of step S304, besides the multimedia object information and the location recommended to play the multimedia object, information of the second-terminal user is sent to the server, such as user name, time of recommendation, and vehicle environment data at the time of recommendation. The present application imposes no restrictions in this regard.

The following implementation example explains the application of the method for recommending multimedia objects in the embodiments of the present application.

While user B is driving by Houhai, the music player is playing “Beijing Beijing.” The user likes it very much and is so touched at the moment in this place that he clicks on the “Recommend” button in the music player for a recommendation. The music player sends the name of the song “Beijing Beijing” to the music map client, and at the same time, the map application sends user B's current position “39°56′25.89″N 116°22′35.22″E,” as the default location recommended to play the music piece, to the music map client; the music map client sends both “Beijing Beijing” and “39°56′25.89″N 116°22′35.22″E” to the music map server for storage according to their correspondence relationships.

When user A drives by Houhai, user A's music map application detects the current location is “39°56′25.89″N 116°22′35.22″E.” It automatically receives the music “Beijing Beijing” related to this location, followed by reminding the user of the music “Beijing Beijing” recommended for this location, adding “Beijing Beijing” to the music player, and playing the song.

With the method for recommending multimedia objects in the embodiments of the present application, it is possible to receive the information of the multimedia object currently playing in the second terminal and the location recommended to play the music, and send the information to the server for storage. Multimedia objects recommended by the second terminal are diversified, therefore, multimedia objects recommended to the first terminal at the joint location are also diversified; at the same time, users can share their thoughts, thus improving user experience for those who make recommendations.

### Embodiment 4

The embodiments of the present application further provide a device for recommending multimedia objects based on the same concept. Because the problem-solving principles of the device are similar to the method for recommending multimedia objects in embodiment 1 of the present invention, the implementation of the method may be consulted when implementing the device. Repeated sections will not be discussed further here.

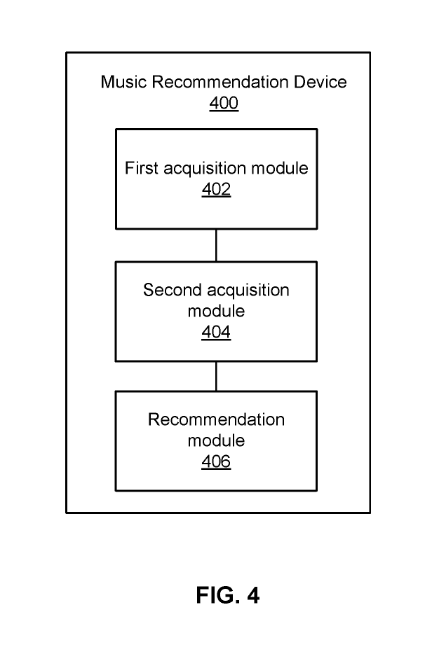

FIG. 4 is a schematic structural diagram of a multimedia object recommendation device in embodiment 4 of the present application.

As shown in FIG. 4, multimedia object recommendation device 400 in embodiment 4 of the present application comprises: first acquisition module 402 for acquiring the location associated with a first terminal; second acquisition module 404 for acquiring information of the multimedia objects related to the location, wherein the multimedia objects comprise ones played at the location and recommended by at least one user; and recommendation module 406 for recommending the multimedia objects to the first terminal.

During specific implementation, the multimedia object recommendation device can be applied to music map applications, multimedia player applications, and map applications. The present application imposes no restrictions in this regard.

Preferably, the location associated with the first terminal comprises: a current location of the first terminal; a first location area with a defined range which comprises the current location of the first terminal; a defined second location that is the target location of the first terminal; or a second location area that is the target area of the first terminal.

Preferably, the first acquisition module is specifically for acquiring the location verified by the user through the map application in the first terminal; or acquiring the location verified by the first terminal through its positioning feature.

Preferably, a first acquisition module is specifically for acquiring the location associated with the first terminal following a defined cycle; or at the time when detected that the position change of the first terminal exceeds the first defined range since the last acquisition.

Preferably, the multimedia object recommendation device in embodiment 4 of the present application further comprises: a first operation receiving module for receiving the first operation command from the user.

Preferably, the first operation command comprises: a command for operating the first defined button which is for triggering the acquisition of the multimedia object information; or a command for operating a defined application which comprises a map application or multimedia player application.

Preferably, a second acquisition module specifically comprises: sending and receiving submodules, for sending the location information to the server and receiving from the server the multimedia object information based on the location; and/or a query submodule, for querying the multimedia object information related to the location from locally stored history information.

Preferably, the multimedia object recommendation device in embodiment 4 of the present application further comprises: a determination and reduction module, for reducing the number of pieces of multimedia object information acquired based on the first defined value, when the number of pieces of information acquired is greater than the first defined value.

Preferably, the multimedia object recommendation device in embodiment 4 of the present application further comprises: an adding module, for adding the multimedia object information acquired to the playlist of the multimedia player application in the first terminal.

Preferably, the multimedia object recommendation device in embodiment 4 of the present application further comprises: a multimedia object number control module for controlling the number of pieces of multimedia object information in the playlist of the multimedia player application to be equal to or less than the second predefined value, if the former is greater than the latter.

Preferably, the multimedia object recommendation device in embodiment 4 of the present application further comprises: a playlist reporting module for reporting the playlist to the server.

Preferably, the multimedia object information comprises: the content or identifier ID of the multimedia object.

Preferably, if the multimedia object information comprises its own identifier ID, then the multimedia object recommendation device in embodiment 4 of the present application further comprises: a content acquisition module, for acquiring the content of the multimedia object based on the ID.

Preferably, the multimedia player applications comprise multimedia object players; or the multimedia objects comprise channels, and the multimedia player applications comprise radios.

Preferably, the recommendation module is specifically for displaying the multimedia object recommendation identifier in the map interface containing the location.

Preferably, the recommendation module is specifically for displaying the multimedia object recommendation identifier at the location in the map interface.

Preferably, the location comprises at least two sub-locations, and the recommendation module is specifically for displaying the multimedia object recommendation identifier at each said sub-location; wherein, multimedia object information at each said sub-location is not exactly the same.

Preferably, the multimedia recommendation identifier comprises: the general identifier of the multimedia object or the identifier of one object of the multimedia objects.

Preferably, the multimedia object recommendation device in embodiment 4 of the present application further comprises: a player module, for playing the multimedia object based on the multimedia object information.

Preferably, the multimedia object recommendation device in embodiment 4 of the present application further comprises: a second operation receiving module, for receiving the user's operation on the multimedia object recommendation identifier.

Preferably, the recommendation module is specifically for playing the multimedia object based on the multimedia object information.

Preferably, the multimedia object recommendation device in embodiment 4 of the present application further comprises: a play information reporting module, for reporting to the server the first terminal's current play information which comprises information of the first terminal's current location and of the multimedia objects playing in the terminal.

Preferably, the play information reporting module is specifically for reporting to the server the current play information in the first terminal based on a defined cycle; or at the time when it is detected that the position change of the first terminal exceeds the second defined range since the last reporting.

With the multimedia object recommendation device in the embodiments of the present application, multimedia objects recommended to play at the location can be recommended to users of the first terminal, based on the location associated with the first terminal. Since multimedia objects are typically recommended to the first terminal, and those recommended at different locations are not exactly the same, the multimedia objects playing in the first terminal are diversified, thus improving the user experience.

### Embodiment 5

The embodiments of the present application further provide a device for recommending multimedia objects based on the same concept. Because the problem-solving principles of the device are similar to the method for recommending multimedia objects in embodiment 2 of the present invention, the implementation of the method may be consulted when implementing the device. Repeated sections will not be discussed further here.

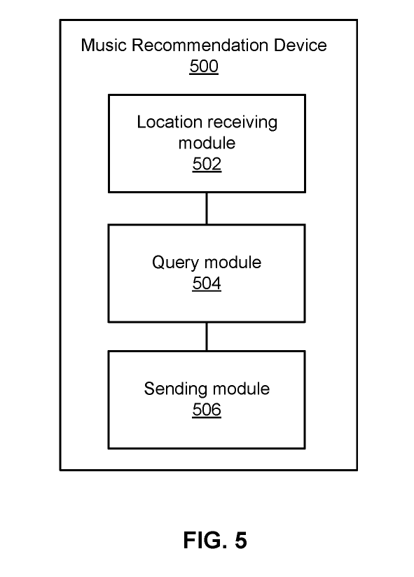

FIG. 5 is a schematic structural diagram of a multimedia object recommendation device in embodiment 5 of the present application.

As shown in FIG. 5, multimedia object recommendation device 500 in embodiment 5 of the present application comprises: location receiving module 502 for receiving the location information associated with the first terminal; query module 504 for querying the multimedia object information related to the location, wherein the multimedia objects include ones played at the location and recommended by at least one user; and sending module 506 for sending the multimedia object information to the first terminal.

During specific implementation, the multimedia object recommendation device can be applied in servers such as a music map server.

Preferably, the multimedia object recommendation device in embodiment 5 of the present application further comprises: a recommendation message receiving module for receiving recommendation messages from at least one user, which comprises information of the multimedia object and the location recommended to play the multimedia object; a storage module for storing the correspondence relationship between the multimedia object information and the location.

Preferably, the multimedia object recommendation device in embodiment 5 of the present application further comprises: a play information receiving module, for receiving and storing the play information in the second terminal which comprises information of the second terminal's current location and of the multimedia object playing in the second terminal; and a correspondence relationship verification module for verifying and storing the correspondence relationship between the multimedia object information and the location.

Preferably, the multimedia object recommendation device in embodiment 5 of the present application further comprises: a playlist receiving and storage module for receiving and storing the playlist in the first terminal.

With the multimedia object recommendation device in the embodiments of the present application, it is possible to receive the location of the first terminal, and query the multimedia objects related to and played at the location which are recommended by at least one user. Since multimedia objects recommended to the first terminal at different locations are not exactly the same, there is a variety of multimedia objects playing in the first terminal, thus improving the user experience.

### Embodiment 6

The embodiments of the present application further provide a device for recommending multimedia objects based on the same invention concept. Because the problem-solving principles of the device are similar to the method for recommending multimedia objects in embodiment 3 of the present invention, the implementation of the method may be consulted when implementing the device. Repeated sections will not be discussed further here.

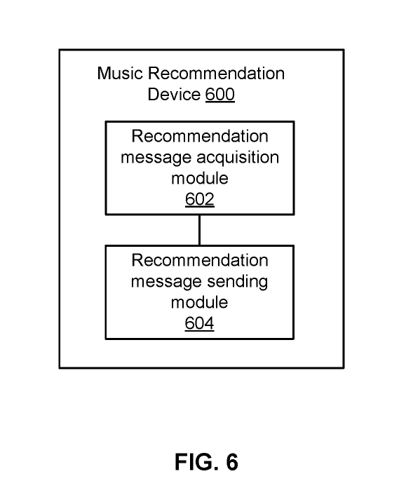

FIG. 6 is a schematic structural diagram of a multimedia object recommendation device in embodiment 6 of the present application.

As shown in FIG. 6., multimedia object recommendation device 600 according to the embodiment 6 of the present application, comprises: a recommendation message acquisition module 602 for acquiring information of the multimedia object that is currently playing in the second terminal and the location recommended to play the multimedia object; and recommendation message sending module 604 for sending the multimedia object information and the location recommended by the user to play the multimedia object.

During specific implementation, the multimedia object recommendation device can be applied to music map applications, multimedia player applications, and map applications; the present application imposes no restrictions in this regard.

Preferably, the multimedia object recommendation device in embodiment 6 of the present application further comprises: a third operation receiving module, for receiving the second operation command input by the user in the second terminal.

Preferably, the second operation command comprises: a command for operating the second defined button in the interface of the map application or multimedia player application. The second defined button is used to trigger the operation to acquire the information of the multimedia object currently playing and the location recommended to play the multimedia object.

Preferably, the recommendation message acquisition module is specifically for acquiring information of the multimedia object currently playing in the multimedia player application in the second terminal.

Preferably, the location recommended to play the multimedia object comprises: the current location of the second terminal; or a third location area with a defined range, wherein the third location area comprising the current location of the second terminal; or a fourth location area with a defined range.

Preferably, the recommendation message acquisition module is specifically for acquiring the location verified by the user through the map application in the second terminal; or acquiring the location verified by the positioning feature of the second terminal.

Preferably, the multimedia object recommendation device in embodiment 6 of the present application further comprises: a play information reporting module, for reporting to the server the current play information in the second terminal, which comprises information of the second terminal's current location and information of the multimedia object playing in the terminal.

Preferably, the play information reporting module is specifically for reporting to the server the current play information in the second terminal based on a defined cycle; or at the time when it is detected that the position change of the second terminal exceeds the second defined range since the last reporting.

With the multimedia object recommendation device in the embodiments of the present application, it is possible to receive information of the multimedia object currently playing at the second terminal and the location recommended to play the multimedia object, and send the information to the server for storage. Multimedia objects recommended by the second terminal are diversified, therefore, multimedia objects recommended to the first terminal at the joint location are also diversified; at the same time, users can share their thoughts, thus improving user experience for those who make recommendations.

### Embodiment 7

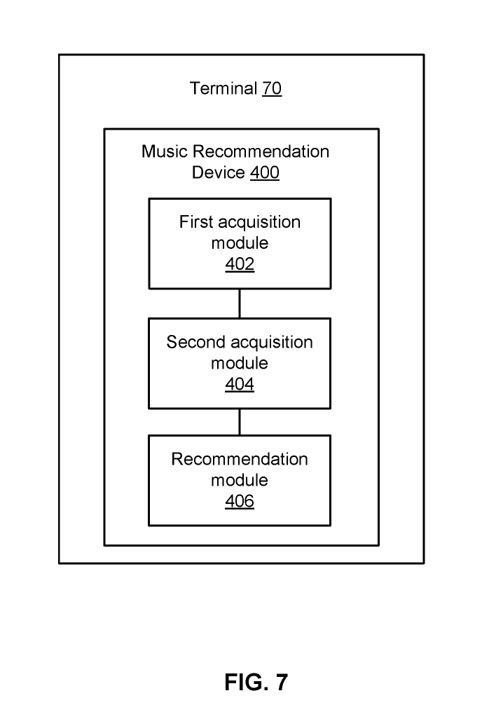

FIG. 7 is a schematic structural diagram of a terminal comprising a multimedia object recommendation device in embodiment 7 of the present application.

As shown in FIG. 7, terminal 70 in embodiment 7 of the present application comprises: multimedia object recommendation device 400.

During specific implementation, the terminal can be a mobile terminal like a cell phone, or a vehicle-mounted terminal, etc.

### Embodiment 8

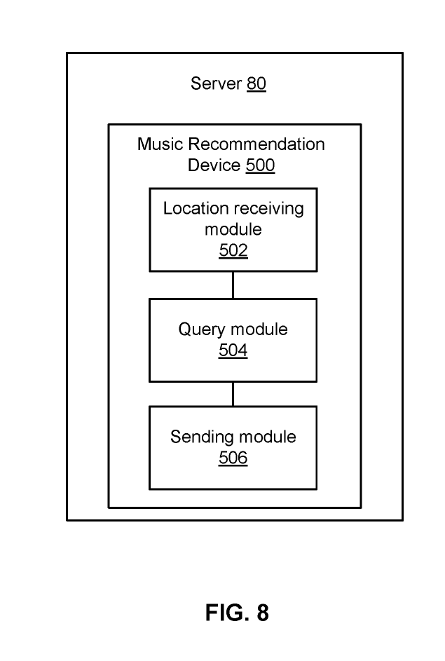

FIG. 8 is a schematic structural diagram of a server comprising a multimedia object recommendation device in embodiment 8 of the present application.

As shown in FIG. 8, server 80 in embodiment 8 of the present application comprises: multimedia object recommendation device 500.

### Embodiment 9

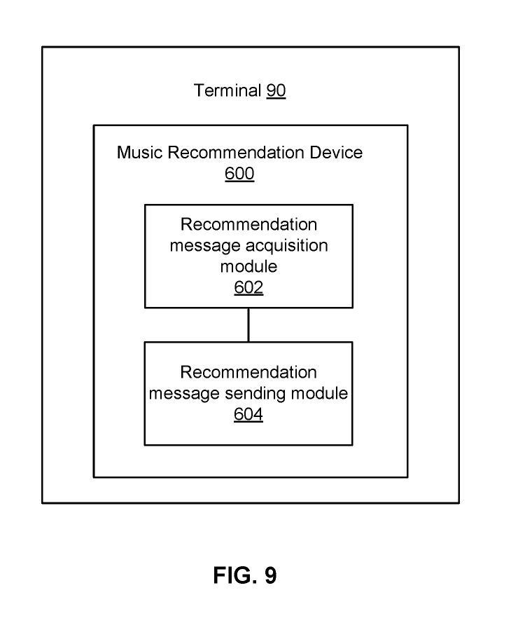

FIG. 9 is a schematic structural diagram of a terminal comprising a multimedia object recommendation device in embodiment 9 of the present application.

As shown in FIG. 9, terminal 90 in embodiment 9 of the present application comprises: multimedia object recommendation device 600.

During specific implementation, the terminal can be a mobile terminal or a vehicle-mounted terminal, etc.

During specific implementation, multimedia object recommendation devices 400 and 600 can exist in the same application; or in different applications; or in the same or different terminals. The present application imposes no restrictions on these.

For example, a user can make recommendations through a multimedia player application, display the correspondence relationship between a multimedia object and the location recommended to play the multimedia object through a map application, and then play the multimedia object with the multimedia player application; the user can also make recommendations through the map application, acquire the multimedia object through the music map application, and then play the multimedia object with the multimedia player application.

### Embodiment 10

The embodiments of the present application further provide a system for recommending multimedia objects based on the same invention concept. Because the problem-solving principles of the system are similar to the method for recommending multimedia objects in embodiments 1 through 3 of the present invention, the implementation of the method may be consulted when implementing the system. Repeated sections will not be discussed further here.

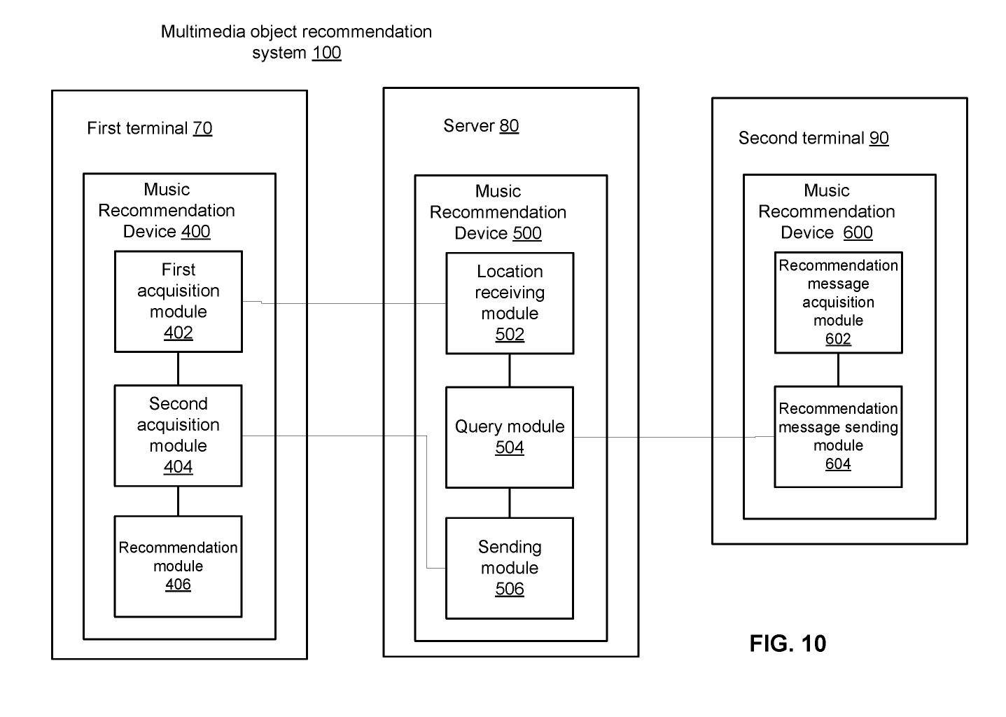

FIG. 10 is a schematic structural diagram of a multimedia object recommendation system in embodiment 10 of the present application.

As shown in FIG. 10, multimedia object recommendation system 100 comprises: first terminal 70 comprising multimedia object recommendation device 400; second terminal 90 comprising multimedia object recommendation device 600; and server 80 comprising multimedia object recommendation device 500.

With the method for recommending multimedia objects in the embodiments of the present application, it is possible to receive information of the multimedia object currently playing in the second terminal and the location recommended to play the multimedia object, and send the information to the server for storage; then based on the location associated with the first terminal, the multimedia object playing at the location is recommended to the first terminal. Since multimedia objects are typically recommended to the first terminal, and those recommended at different locations are not exactly the same, the multimedia objects playing in the first terminal are diversified, thus improving the user experience.

A person skilled in the art should understand that the embodiment of the present application can be provided as methods, systems, or computer software products. Therefore, the present application may take the form of complete hardware embodiments, complete software embodiments, or embodiments that combine software and hardware. In addition, the present application can take the form of computer program products implemented on one or more computer-operable storage media (comprising but not limited to magnetic disk storage devices, CD-ROMs, and optical storage devices) containing computer operable program codes.

The present application is described with reference to flowcharts and/or block diagrams based on methods, devices (systems), and computer program products. Please note that each flowchart and/or block diagram within the flowcharts and/or block diagrams and combinations of flowcharts and/or block diagrams within the flowcharts and/or block diagrams can be realized by computer commands. One can provide these computer commands to a general-purpose computer, a specialized computer, an embedded processor, or the processor of other programmable data equipment so as to give rise to a machine, with the result that the commands executed through the computer or processor of other programmable data equipment give rise to a device that is used to realize the functions designated by one or more processes in a flowchart and/or one or more blocks in a block diagram.

These computer program commands can also be stored in computer-readable memory that guides the computer or other programmable data processing equipment to operate in a specified manner, so that the commands stored in this computer-readable memory give rise to a product that comprises the command device, and this command device realizes the functions designated in one or more processes in a flowchart and/or one or more of the blocks in a block diagram.

These computer program commands can also be loaded onto a computer or other programmable data equipment, with the result that a series of operating steps are executed on a computer or other programmable equipment so as to give rise to computer processing. In this way, the commands executed on a computer or other programmable equipment provide steps for realizing the functions designated by one or more processes in a flowchart and/or one or more blocks in a block diagram.

Although preferred embodiments of the present application have already been described, a person skilled in the art can make other modifications or revisions to these embodiments once they grasp the basic creative concept. Therefore, the attached claims are to be interpreted as comprising the preferred embodiments as well as all modifications and revisions falling within the scope of the present application.

Obviously, a person skilled in the art can modify and vary the present application without departing from the spirit and scope of the present invention. Thus, if these modifications to and variations of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1-61. (canceled)

62. A method, comprising:
obtaining a location associated with a first terminal;
identifying a multimedia object that has been played in relation to the location associated with the first terminal and that the multimedia object has been recommended by at least one user in relation to the location associated with the first terminal; and
recommending the multimedia object to the first terminal.

63. The method of claim 62, wherein the location associated with the first terminal comprises a current location associated with the first terminal and wherein the current location associated with the first terminal includes one or more of: a current set of coordinate information associated with the first terminal, a building in which the first terminal is currently located, a logical space in which the first terminal is currently located, and a defined range in which the first terminal is currently located.

64. The method of claim 62, wherein:
the location associated with the first terminal comprises a target location associated with the first terminal;
the target location is different from a current location associated with the first terminal; and
the target location associated with the first terminal includes one or more of: a target set of coordinate information, a building in which the target location is located, and a logical space in which the target location is located.

65. The method of claim 62, wherein:
the location associated with the first terminal comprises a target location associated with the first terminal;
the target location is different from a current location associated with the first terminal; and
the method further comprises receiving an indication that the current location associated with the first terminal has arrived at the target location associated with the first terminal and wherein the multimedia object is played at the first terminal in response to the indication.

66. The method of claim 62, wherein the location associated with the first terminal comprises a previous location and further comprising:
determining the first terminal has changed its position;
receiving an indication that a distance between the previous location associated with the first terminal and a current location associated with the first terminal exceeds a first defined range; and
in response to the indication:
obtaining a new multimedia object related to the current location associated with the first terminal, wherein the new multimedia object has been played in relation to the current location and wherein the new multimedia object is recommended by at least another user in relation to the current location; and
recommending the new multimedia object to the first terminal.

67. The method of claim 62, further comprising adding the multimedia object to a playlist of a multimedia player application executing at the first terminal.

68. The method of claim 62, wherein recommending the multimedia object at the first terminal comprises presenting a multimedia object recommendation identifier associated with the multimedia object at a map interface that includes the location associated with the first terminal.

69. The method of claim 62, wherein recommending the multimedia object at the first terminal comprises presenting a multimedia object recommendation identifier associated with the multimedia object at a map interface that includes the location associated with the first terminal further comprises presenting the multimedia object recommendation identifier at the location associated with the first terminal at the map interface.

70. The method of claim 62, wherein the location associated with the first terminal comprises a first sub-location and a second sub-location, wherein recommending the multimedia object at the first terminal comprises:
presenting a first multimedia object recommendation identifier at the first sub-location at the map interface; and
presenting a second multimedia object recommendation identifier at the second sub-location at the map interface, wherein the first multimedia object recommendation identifier and the second multimedia object recommendation identifier are not the same.

71. The method of claim 62, wherein identifying the multimedia object is performed in response to an indication that a user has input an operation command to trigger the identification of the multimedia object.

72. The method of claim 62, wherein identifying the multimedia object that has been played in relation to the location associated with the first terminal and that the multimedia object has been recommended by the at least one user in relation to the location associated with the first terminal comprises:
determining that a network connection to a server is unavailable; and
in response to the determination that the network connection is unavailable, perform a local query at the first terminal for the multimedia object.

73. The method of claim 62, wherein the multimedia object comprises a first multimedia object and further comprising:
receiving from a second terminal a recommendation to play a second multimedia object in relation to a location associated with the second terminal; and
storing, in a data structure, a correspondence between the second multimedia object and the location associated with the second terminal.

74. The method of claim 62, wherein the multimedia object comprises a first multimedia object and further comprising:
receiving from a second terminal a recommendation to play a second multimedia object in relation to a location associated with the second terminal; and
updating, in a data structure, a number of users associated with a correspondence between the second multimedia object and the location associated with the second terminal.

75. The method of claim 62, wherein the multimedia object comprises a first multimedia object and the method further comprises receiving from a second terminal a recommendation to play a second multimedia object in relation to a location associated with the second terminal, wherein the second multimedia object is selected in response to a user operation of a control that is presented in a multimedia player application executing at the second terminal and wherein the location associated with the second terminal is determined by a map application executing at the second terminal.

76. A computer program product, the computer program product comprising a non-transitory computer readable storage medium and comprising computer instructions for:
obtaining a location associated with a first terminal;
identifying a multimedia object that has been played in relation to the location associated with the first terminal and that the multimedia object has been recommended by at least one user in relation to the location associated with the first terminal; and
recommending the multimedia object to the first terminal.

77. The computer program product of claim 76, wherein the location associated with the first terminal comprises a previous location and further comprising:
determining the first terminal has changed its position;
receiving an indication that a distance between a previous location associated with the first terminal and a current location associated with the first terminal exceeds a first defined range; and
in response to the indication:
obtaining a new multimedia object related to the current location associated with the first terminal, wherein the new multimedia object has been played in relation to the current location and wherein the new multimedia object is recommended by at least another user in relation to the current location; and
recommending the new multimedia object at the first terminal.

78. The computer program product of claim 76, wherein recommending the multimedia object at the first terminal comprises presenting a multimedia object recommendation identifier associated with the multimedia object at a map interface that includes the location associated with the first terminal.

79. The computer program product of claim 76, wherein the multimedia object comprises a first multimedia object and further comprising:
receiving from a second terminal a recommendation to play a second multimedia object in relation to a location associated with the second terminal; and
storing, in a data structure, a correspondence between the second multimedia object and the location associated with the second terminal.

80. The computer program product of claim 76, wherein the multimedia object comprises a first multimedia object and the computer instructions further comprise receiving from a second terminal a recommendation to play a second multimedia object in relation to a location associated with the second terminal, wherein the second multimedia object is selected in response to a user operation of a control that is presented in a multimedia player application executing at the second terminal and wherein the location associated with the second terminal is determined by a map application executing at the second terminal.

81. A system, comprising:
a processor; and
a memory coupled with the processor, wherein the memory is configured to provide the processor with instructions which when executed cause the processor to:
obtain a location associated with a first terminal;
identify a multimedia object that has been played in relation to the location associated with the first terminal and that the multimedia object has been recommended by at least one user in relation to the location associated with the first terminal; and
recommend the multimedia object to the first terminal.
